(19) United States
(12) Patent Application Publication
(10) Pub. No.: US 2016/0121281 A1
(43) Pub. Date: May 5, 2016

(54) MAGNETIC COUPLING AND MIXING DEVICE

(71) Applicant: TECAN TRADING AG, Männedorf (CH)

(72) Inventor: Thomas GEIGES, Mannedorf (CH)

(73) Assignee: TECAN TRADING AG, Mannedorf (CH)

(21) Appl. No.: 14/895,522

(22) PCT Filed: Jun. 6, 2013
(86) PCT No.: PCT/EP2013/061636

§ 371 Date: Dec. 3, 2015

(51) Int. Cl. B01F 13/08; B01F 3/08

(52) U.S. Cl. CPC B01F 13/08; B01F 3/0853

(57) ABSTRACT

A device for mixing liquids in a container having an inner chamber with an enclosing wall and a bottom, an external encasement, an interspace and a transfer opening on top of the inner chamber. A mixing body located in the inner chamber comprises magnetizable material or a permanent magnet spaced from the wall. A coupling body movable in the interspace along a longitudinal axis and wall has magnetic working connection with the mixing body. The wall and the external encasement are transparent to magnetic fields. An acting permanent magnet or magnetizable material outside the external encasement, is in magnetic working connection with the coupling body. Moving the acting magnet or magnetizable material parallel to the longitudinal axis induces movement of the coupling body inside the interspace and moving the mixing body in the inner chamber, mixes liquids present in the inner chamber.

### TECHNICAL FIELD OF THE INVENTION

The invention relates to a device for mixing liquids of different viscosity or composition within at least one container. Mixing is carried out by moving e.g. a mixing body inside of and along the walls of a lengthy container with an essentially constant diameter that is slightly larger then the diameter of the mixing body. Typically, the mixing body comprises magnetizable material and is moved inside of the container by magnetic interaction trough the wall of the container.

### PRIOR ART RELATED TO THE INVENTION

Physical coupling of movable bodies by magnetic coupling through the walls of containments are known from the prior art. U.S. Pat. No. 6,935,828 B2 discloses transport platforms that horizontally move wafers inside of a vacuum load lock. These platforms are guided by rails and moved by a drive that is located outside of the vacuum load lock. The drive is coupled to the transport platform by magnetic interaction or by a magnetic working connection respectively. The magnetic coupling thus acts through the load lock wall which is transparent for magnetic fields for this purpose. EP 0 603 471 B1 discloses a drive unit for moving items with a tubular housing on which a movable unit is longitudinally guided. The movable part comprises a driving member that is located inside of the housing and also a driven part that is located outside of the housing and that is magnetically coupled through the wall of the housing to the driving member. Both, the driving member and the driven member comprise permanent magnets. The driving device for moving items is characterized in that the wall between the driving member and the driven member has one or more strip-like wall sections with smooth extension extending along the possible stroke of the movement unit, and that the two magnetic devices each have a smooth extension and are aligned parallel to the smooth wall section which runs between the two magnetic devices. Further it is known from the prior art a generic mixing device and method for mixing liquids of different viscosity or composition within at least one container. Mixing is carried out by moving a mixing sphere inside of and along the walls of a lengthy container with an essentially constant diameter that is slightly larger then the working area of the mixing sphere, which comprises magnetizable material, and which is moved inside of the container by magnetic interaction trough the wall of the container.

### OBJECT AND SUMMARY OF THE INVENTION

It is an object of the invention to provide an alternative device and method for mixing liquids of different viscosity or composition within at least one container, when mixing is carried out by moving a mixing body inside of and along the walls of a lengthy container with an essentially constant diameter that is slightly larger then the working area of the mixing body, which mixing body comprises magnetizable material or a permanent magnet and is moved inside of the container by magnetic interaction trough the wall of the container.

This object is achieved by the current invention as herein disclosed. In a first aspect of the invention, a device for mixing liquids of different viscosity or composition within at least one container is proposed. Each one of the containers for carrying out the invention comprises:
i) an inner chamber with a longitudinal axis and a chamber cross-section area that extends perpendicular to the longitudinal axis, the chamber cross-section area being substantially constant over at least a working part of the inner chamber;
ii) an external encasement with a bottom opening, the external encasement being attached to the container at an upper part of the latter;
iii) a wall that encloses the inner chamber and that is spaced apart from the external encasement by an interspace, the wall and the external encasement being configured to be transparent to magnetic fields;
iv) a bottom that is attached to the wall and that closes the inner chamber at a bottom side; and
v) a transfer opening that is located at a top side of the inner chamber.

Preferably, there is located within the working part of the inner chamber at least one mixing body, each mixing body comprising magnetizable material or a permanent magnet and defining a body cross-section area that adds up to a sum of body cross-section areas. It is especially preferred that the sum of body cross-section areas is less than the chamber cross-section area and that the at least one mixing body is spaced apart by a distance from the wall.

The mixing device according to the present invention is characterized in that it further comprises:
vi) a coupling body that is configured to be introducible into the interspace via the bottom opening of the external encasement and that is movable in the interspace substantially in direction of the longitudinal axis and alongside the wall, the coupling body comprising a first permanent magnet and/or a mass of magnetizable material that in each case through the wall is in magnetic working connection with the at least one mixing body such that moving the coupling body alongside the wall simultaneously induces moving the at least one mixing body in the working part of the inner chamber; and
vii) at least one acting permanent magnet or acting magnetizable material that is located outside the external encasement and that through the external encasement is in magnetic working connection with the first permanent magnet, a second permanent magnet, or the mass of magnetizable material of the coupling body such that moving the at least one acting permanent magnet or acting magnetizable material at least substantially parallel to the longitudinal axis of the inner chamber simultaneously induces movement of the coupling body inside the interspace, thereby moving the at least one mixing body in the inner chamber, and thus mixing of liquids that are present in the working part of the inner chamber of the container.

Preferably, the mixing device comprises at least one container.

It is particularly preferred that the chamber cross-section area of the working part of the inner chamber is selected from a group of cross-section areas that consists of circles, ellipses, ovals, polygons, and combinations of circles, ellipses, ovals, and polygons. Of special preference however is a circular chamber cross-section area. It is preferred in addition that the mixing device further comprises an actuating unit to which the at least one acting permanent magnet or acting magnetizable material is attached, the actuating unit being configured to reciprocally move the at least one acting permanent magnet or acting magnetizable material linearly and substantially parallel to the longitudinal axis of the inner chamber of a container that is placed at the mixing device.

In a second aspect of the invention, a method of mixing liquids of different viscosity or composition within at least one container while using a mixing device of the current invention is proposed. The method according to the invention comprises:
a) introducing of liquids to be mixed into an inner chamber of a container of the mixing device, each container comprising:
   i) an inner chamber with a longitudinal axis and a chamber cross-section area that extends perpendicular to the longitudinal axis, the chamber cross-section area being substantially constant over at least a working part of the inner chamber;
   ii) an external encasement with a bottom opening, the external encasement being attached to the container at an upper part of the latter;
   iii) a wall that encloses the inner chamber and that is spaced apart from the external encasement by an interspace, the wall and the external encasement being configured to be transparent to magnetic fields;
   iv) a bottom that is attached to the wall and that closes the inner chamber at a bottom side; and
   v) a transfer opening that is located at a top side of the inner chamber;
b) placing within the working part of the inner chamber at least one mixing body, each mixing body comprising magnetizable material or a permanent magnet and defining a body cross-section area that adds up to a sum of body cross-section areas, the sum of body cross-section areas being less than the chamber cross-section area and the at least one mixing body being spaced apart by a distance from the wall;
c) introducing a coupling body into the interspace via the bottom opening of the external encasement, the coupling body being movable in the interspace substantially in direction of the longitudinal axis and alongside the wall, the coupling body comprising a first permanent magnet and/or a mass of magnetizable material that in each case through the wall is in magnetic working connection with the at least one mixing body such that moving the coupling body alongside the wall simultaneously induces moving the at least one mixing body in the working part of the inner chamber; and
d) moving at least one acting permanent magnet or acting magnetizable material, which is located outside the external encasement, and which through the external encasement is in magnetic working connection with the first permanent magnet, a second permanent magnet, or the mass of magnetizable material of the coupling body, at least substantially parallel to the longitudinal axis of the inner chamber, simultaneously inducing movement of the coupling body inside the interspace, thereby moving the at least one mixing body in the inner chamber, and thus mixing of liquids that are present in the working part of the inner chamber of the container.

In a third aspect of the invention, a corresponding use of a device of the current invention for mixing liquids of different viscosity or composition within at least one container is proposed. Additional preferred embodiments and inventive features derive from the dependent claims in each case.

### Advantages of the Present Invention Comprise

The coupling body of the mixing device of the current invention comprises at least one of a group of elements that consists of permanent magnets and magentizable materials and it bridges a relatively large distance between the actuating unit (or driving member) to the mixing body (or driven member) that is due to the construction of the container utilized.
The coupling body of the mixing device of the current invention enables inducing movement of the mixing body inside of the container without the necessity of inserting and directly driving an actuation element that reaches through the bottom opening of the external encasement of the container.
The coupling body of the mixing device of the current invention provides magnetic coupling force that is strong enough to cause movement of the mixing body inside of the container by simply moving the actuation unit outside of the container.
The liquids to be mixed may exhibit a temperature that is well below ambient temperature and thus high viscosity due to previous storage in a refrigerator. Mixing can be carried out inside a space that is thermally insolated from the surroundings and from the drive that moves the actuation unit outside of the container.
The coupling body of the mixing device of the current invention provides strong magnetic coupling between the actuating unit and the mixing body that are located at such a distance to each other that even selecting a permanent magnet in the actuating unit and also in the mixing body would result in a too weak magnetic coupling for successfully moving the mixing body in viscous liquids.

### BRIEF INTRODUCTION TO THE ATTACHED DRAWINGS

The mixing device, the method of mixing, and the use of the device for mixing liquids of different viscosity or composition within at least one container is now described with the aid of the attached schematic drawings that merely show preferred and exemplary embodiments and that shall not limit the gist of the current invention. There is shown in:

FIG. 1 a 3D presentation of a mixing device according to a first embodiment that is configured as a stand-alone instrument;

FIG. 2 four variants of linearly arranging a mixing body, a coupling body, and an acting permanent magnet or acting magnetizable material along a first essentially horizontal axis;

FIG. 3 three variants of angular arranging a mixing body and a coupling body along a first essentially horizontal axis in combination with arranging the coupling body and an acting permanent magnet or acting magnetizable material along a second essentially horizontal axis;

FIG. 4 additional variants of linearly arranging at least one mixing body, a coupling body, and an acting permanent magnet along a first or second essentially horizontal axis;

FIG. 5 a particularly preferred variant of arranging one mixing body, a coupling body, and an acting permanent magnet along a first, second, and third essentially horizontal axis;

FIG. 6 a vertical section through a mixing device according to a second embodiment that is configured as a liquid handling workstation.

### DETAILED DESCRIPTION OF THE INVENTION

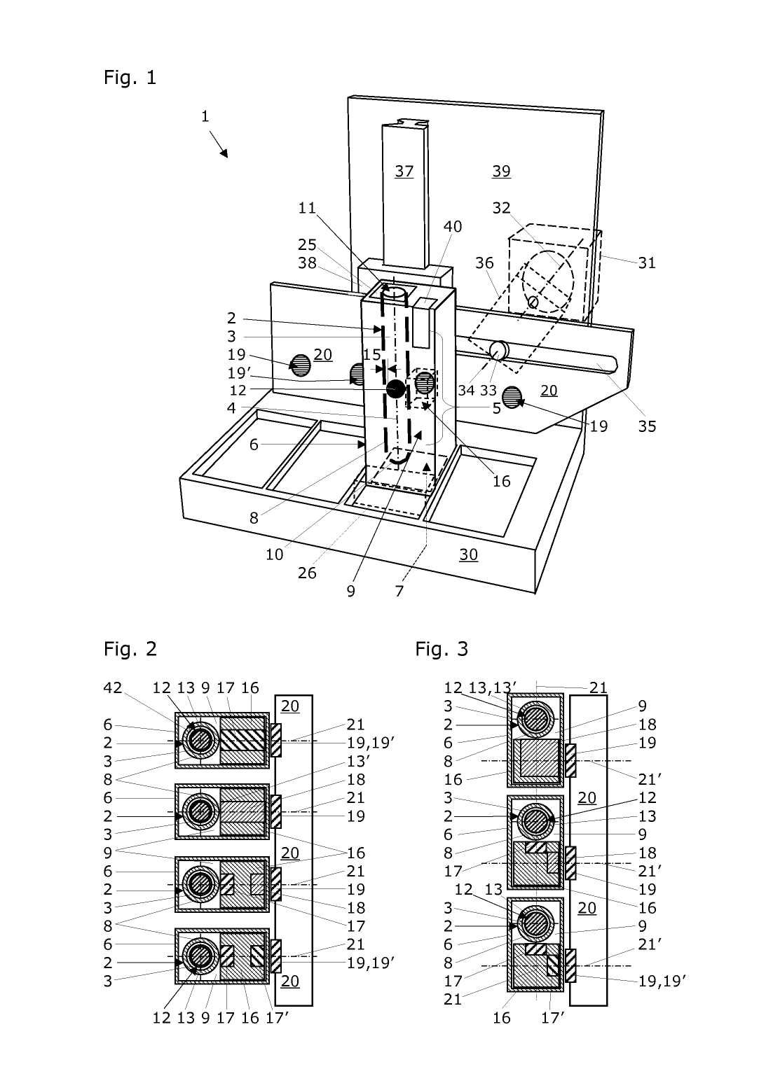

FIG. 1 shows a 3D presentation of a mixing device 1 according to a first embodiment of the present invention that is configured as a stand-alone instrument. The device 1 is configured for mixing liquids of different viscosity or composition within at least one container 2. Preferably, the mixing device 1 comprises at least on container 2. Containers 2 that are suited for carrying out the current invention are known e.g. from DAKO Inc. (a Danish company owned by Agilent Technologies).

Each container 2 comprises an inner chamber 3 with a longitudinal axis 4 and with a chamber cross-section area 3′ (see e.g. FIG. 6) that extends perpendicular to the longitudinal axis 4. The chamber cross-section area 3′ is substantially constant over at least a working part 5 of the inner chamber 3; if required by the manufacturing process for producing such containers 2 (e.g. by injection molding), the cross-section area 3′ can slightly increase towards the upper part of the inner chamber 3 for ease of de-molding.

Each container 2 comprises an external encasement 6 with a bottom opening 7. The external encasement 6 typically is attached to the container 2 at an upper part of the latter. Each container 2 further comprises a wall 8 that encloses the inner chamber 3 and that is spaced apart from the external encasement 6 by an interspace 9. The wall 8 and the external encasement 6 are configured to be transparent to magnetic fields. Preferably, the entire container 2 is manufactured of a plastic material (e.g. polypropylene) by injection molding.

Each container 2 also comprises a bottom 10 that is attached to the wall 8 and that closes the inner chamber 3 at a bottom side. Typically, the bottom 10 is located at an elevated level with respect to the bottom opening 7 of the external encasement 6. The external encasement 6 preferably has a flat footprint that enables the container 2 to place on every flat at least approximately horizontal surface.

Each container 2 in addition comprises a transfer opening 11 that is located at a top side of the inner chamber 3. This transfer opening 11 can be essentially flush with an upper surface of the external encasement 6 of the container 2 (as shown in FIG. 1) or can comprise a neck portion 11′ (see FIG. 6). Preferably, the neck portion 11′ comprises an external thread 23 for screwing on a screw cap 24 with a respective internal tread. Whether the transfer opening 11 is essentially flush or equipped with a neck portion 11′, it can be sealed with a lid 25. Preferably, the lid may be pierced with a piercing pipette 28 (see FIG. 6) or pipette tip for adding liquids to or for withdrawing liquids from the inner chamber 3.

The liquids to be mixed can be of any composition. Often, the liquids to be mixed have a different viscosity because they are stored in a refrigerator and they are only taken out from the cold for mixing and then for staining biological samples on slides for light microscopy. Thus, at least a part of the liquids preferably comprise buffers that are used for staining cells and tissues on microscope slides. Preferably the mixing process is carried out inside of a thermally insolated space or box 49 in order to prevent the liquids to be mixed from heating up to room temperature (see FIG. 6).

For mixing the liquids inside the working part 5 of the inner chamber 3, at least one mixing body 12 is added or already provided in the inner chamber 3 of the container 2. Such a mixing body 12 preferably has a shape that prevents the mixing body 12 from canting within the inner chamber 3 and thus from blocking its reciprocal movement within the inner chamber 3 of the container 2. Preferably, the mixing body 12 (if only one is used) or the mixing bodies (if two or more are used) are of a polyhedron or spherical shape. Also mixing bodies 12 configured as spheres with some flat areas (i.e. a combination of a spherical and polyhedral shape) are feasible. Mixing bodies 12 with a spherical shape are particularly preferred. Of special preference is the use of one mixing body 12 per container 2.

Each mixing body 12 comprises magnetizable material 13 or a permanent magnet 13′ (see FIGS. 2-4). Such magnetizable material 13 can be selected for example from iron, nickel, rare earths, from alloys or composite materials that comprise iron, nickel or rare earths, or from any other magnetizable material. Such magnetizable material 13 can be a permanent magnet itself. In order to separate the magnetizable material 13 or permanent magnet 13′ of a mixing body 12 from the liquids to be mixed, the mixing body 12 may comprise a cover layer or coating 42 (see e.g. FIG. 2) from a chemically inert material, such as polypropylene (PP) or polytetrafluorethylene (PTFE) or a coating from noble metals (such as gold, platinum or their alloys) for example. Of particular preference is a mixing body 12 with gold coating on its surface. Each mixing body 12 preferably has a smooth surface. Alternatively, the mixing bodies 12 can have a surface with corrugations and/or depressions, provided that these un-even surfaces do not cause the mixing bodies 12 to be stuck inside of the inner chamber 3.

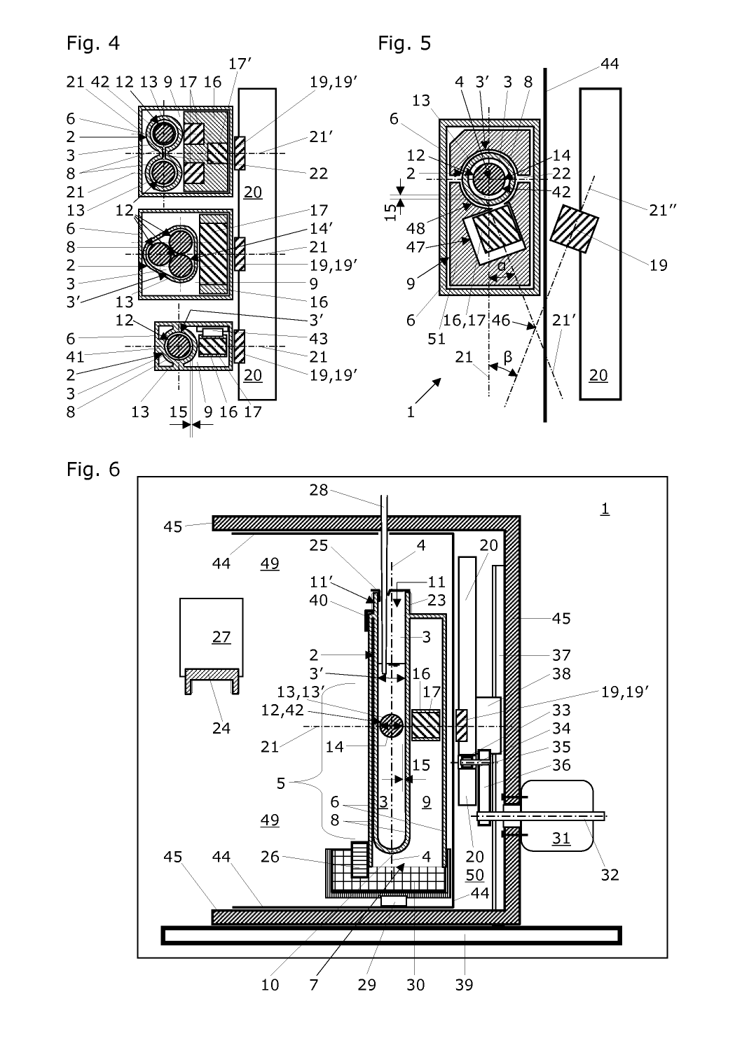

Each mixing body 12 defines a body cross-section area 14 (see e.g. FIG. 6). If more than one mixing bodies 12 are utilized inside the inner chamber 3 (see e.g. FIG. 4), the body cross-section areas 14 may be added up to a sum of body cross-section areas 14′. In general, the sum of body cross-section areas 14′ inside of one inner chamber 3 and arranged on at least approximately the same horizontal level must be less than the chamber cross-section area 3′ in order to let pass liquids between the mixing bodies 12 and the wall 8 of the container 2 (see e.g. FIG. 4). In addition, the at least one mixing body 12 must be spaced apart by a distance 15 from the wall 8. Preferably, a mixing body 12 is spaced apart by the distance 15 from the surrounding wall 8 along its entire circumference. This distance 15 is dependent from the size of the mixing body 12 and of the chamber cross-section area 3′. Preferably, the distance 15 is between 1 and 25% of a diameter of a spherical mixing body 12 or an equivalent with respect to a polyhedral mixing body 12.

Deviating from the arrangement of mixing bodies 12 on essentially the same horizontal level as depicted in FIG. 4, two or more mixing bodies 12 could be arranged in a circular inner chamber 3 of the container 2 on top of each other. In such a case, each mixing body 12 must individually be spaced apart by a distance 15 from the wall 8.

According to the present invention, the mixing device 1 comprises a coupling body 16 that is configured to be introducible into the interspace 9 of the container 2 via the bottom opening 7 of the external encasement 6. This coupling body 16 is reciprocally movable in the interspace 9 substantially in direction of the longitudinal axis 4 and alongside the wall 8 of the inner chamber 3. The coupling body 16 comprises a first permanent magnet 17 and/or a mass of magnetizable material 18 that in each case through the wall 8 is in magnetic working connection with the at least one mixing body 12 such that moving the coupling body 16 alongside the wall 8 (i.e. at least approximately parallel to the longitudinal axis 4) simultaneously induces moving the at least one mixing body 12 in the working part 5 of the inner chamber 3 (see FIGS. 2-5) in the same direction. The working part 5 of the inner chamber 3 is defined by the potential height of stroke of the at least one mixing body 12 inside the inner chamber 3.

In addition and according to the present invention, the mixing device 1 further comprises at least one acting permanent magnet 19 or acting magnetizable material 19′ that is located outside the external encasement 6 and that through the external encasement 6 is in magnetic working connection with the first permanent magnet 17, a second permanent magnet 17′, or the mass of magnetizable material 18 of the coupling body 16 (for variants see FIGS. 2-5).

The magnetic working connections just mentioned are such that reciprocally moving the at least one acting permanent magnet 19 or acting magnetizable material 19′ at least substantially parallel to the longitudinal axis 4 of the inner chamber 3 simultaneously induces similar movement of the coupling body 16 inside the interspace 9. Movement of the coupling body 16 inside the interspace 9 thereby moves the at least one mixing body 12 in the inner chamber 3. Moving the at least one mixing body 12 in the inner chamber 3 finally causes mixing of liquids that are present in the working part 5 of the inner chamber 3 of the container 2 (see FIGS. 2-5).

Preferably, the acting permanent magnet 19 is or the acting permanent magnets 19, or the acting magnetizable material 19′ respectively, are attached to an actuation unit 20 that is movable up and down in a plane essentially parallel to the longitudinal axis 4 of the inner chamber 3 of the container(s) 2. Preferably this reciprocal movement is at least approximately in a vertical direction.

In the FIG. 1, there is presented possible equipment for driving the actuation unit 20. The actuation unit 20 is mounted on a cart 38 which is movable along a linear guide 37. The linear guide 37 is attached to a wall or support 39 which is connected to a base 30 for supporting one or more containers 2. The actuation unit 20 of this exemplary first embodiment comprises a (preferably horizontally extending) long slot 35 in which a drive wheel 33 is guided movable. The drive wheel axle 34 is connected to a drive lever 36 which in turn is connected to the drive axle 32 of a drive 31. The drive axle 32 reaches through the wall 39.

As the liquids to be mixed can exhibit considerably viscosity, it often is advisable to fix the containers 2 on the base 30 they are standing on. Such fixing may e.g. be provided by one or more blocking elements 26 that are connected to the base 30 and that clamp the container(s) 2 to hold them in place during mixing of the viscose liquids. Such fixing may additionally or alternatively be provided by one or more holding members 40 that are configured to hold down the container(s) 2 to the base 30 during mixing of the viscose liquids. In FIG. 1, in one row and about on the same horizontal level, two acting permanent magnets 19 and two masses of acting magnetizable material 19′ are shown for illustration purposes. It is preferred however that only one sort of acting material, acting permanent magnets 19 or acting magnetizable material 19′ is utilized in the same instrument.

FIG. 2 shows four variants of linearly arranging a mixing body 12, a coupling body 16, and an acting permanent magnet 19 or acting magnetizable material 19′ along a first essentially horizontal axis 21. In this FIG. 2, all mixing bodies 12 comprise a magnetizable material 13 or permanent magnet 13′ and are shown with a cover layer 42 that coats the magnetizable material 13 or permanent magnet 13′. All coupling bodies 16 are shown to almost fill the area of the interspace 9 between the wall 8 of the inner chamber 3 and the external encasement 6 so that the coupling body 16 is guided in its movement along the longitudinal axis 4 (see FIGS. 1 and 6) of the inner chamber 3 on all sides. Of course, there need to be some play on all sides of the coupling body 16 so that it may freely move in the desired direction. Preferably, the coupling body 16 comprises a combination of materials, a plastic body material and a material that is selected from a group of materials consisting of a first permanent magnet 17, a second permanent magnet 17′, and a magnetizable material 18. The plastic material preferably is polytetrafluorethylene (PTFE) that exhibits lubricant characteristics. The first and second permanent magnets 17,17′ preferably are from composites of rare earths because of their strong magnetic field. The magnetizable material 18 can be selected for example from iron, nickel, rare earths, from alloys or composite materials that comprise iron, nickel or rare earths, or from any other magnetizable material.

In general, all acting permanent magnets 19 or acting magnetizable materials 19′ are arranged such that one of the poles (the north pole for all examples discussed in this patent application) is directed to the container 2 that the acting permanent magnet 19 is dedicated to.

Each coupling body 16 accomplishes the task of bridging the long distance between one or more mixing bodies 12 in the inner chamber 3 of a particular container 2 and the acting permanent magnet 19 or acting magnetizable material 19′ that is dedicated to this particular container 2. This task is accomplished on the one hand by minimizing the distance between the one or more mixing bodies 12 in the inner chamber 3 of a particular container 2 and the coupling body 16 in the interspace 9 of this container 2. This task is accomplished on the other hand by minimizing the distance between the coupling body 16 in the interspace 9 of this container 2 and the acting permanent magnet 19 or acting magnetizable material 19′ that is dedicated to this particular container 2.

Starting from top, the first variant in FIG. 2 is characterized in that the coupling body 16 comprises one first permanent magnet 17 that reaches through the entire coupling body 16 in the direction of a first essentially horizontal axis 21. This first permanent magnet 17 has one of the poles directed to the mixing body 12 and the other pole directed to the acting permanent magnet 19 that preferably is attached to an actuating unit 20. It may be preferred that a thin coating covers one or both poles of the first permanent magnet 17. The thin coating (not shown) may be of the plastic material of the coupling body 16 or of another material (e.g. PTFE). It is preferred that the polarity of the first permanent magnet 17 of the coupling body 16 is the same as the polarity of the acting permanent magnet 19. In consequence, the magnetic field between the north pole of the acting permanent magnet 19 and the south pole of the first permanent magnet 17 build up the magnetic working connection between the actuation unit 20 and the coupling body 16 here. The magnetic field between the north pole of the first permanent magnet 17 and the magnetizable material 13 build up the magnetic working connection between the coupling body 16 and the mixing body 12 here. In the first variant just described, the acting material of the actuation unit 20 could be a magnetizable material 19′ instead of a permanent magnet 19.

Starting from top, the second variant in FIG. 2 is characterized in that the coupling body 16 comprises a mass of magnetizable material 18 that reaches through the entire coupling body 16 in the direction of a first essentially horizontal axis 21. This mass of magnetizable material 18 has one of its sides directed to the mixing body 12 and the opposite side directed to the acting permanent magnet 19 that preferably is attached to an actuating unit 20. It may be preferred that a thin coating covers one or both of these sides of the mass of magnetizable material 18. The thin coating (not shown) may be of the plastic material of the coupling body 16 or of another material (e.g. PTFE). In consequence, the magnetic field between the north pole of the acting permanent magnet 19 and the induced south pole of the mass of magnetizable material 18 build up the magnetic working connection between the actuation unit 20 and the coupling body 16 here. The magnetic field between the induced north pole of the mass of magnetizable material 18 and the magnetizable material 13 build up the magnetic working connection between the coupling body 16 and the mixing body 12 here. In the second variant just described, the mixing body 12 could comprise a permanent magnet 13′ instead of a magnetizable material 13.

Starting from top, the third variant in FIG. 2 is characterized in that the coupling body 16 comprises one first permanent magnet 17 and a mass of magnetizable material 18 that both only fill a part of the coupling body 16, but that both are aligned on a first essentially horizontal axis 21. This first permanent magnet 17 has one of the poles directed to the mixing body 12 and the other pole directed to the inside of the coupling body 16 and towards the mass of magnetizable material 18. One side of the mass of magnetizable material 18 is directed to the acting permanent magnet 19 that preferably is attached to an actuating unit 20; the other side of the mass of magnetizable material 18 is directed to the first permanent magnet 17. It is preferred that the polarity of the first permanent magnet 17 of the coupling body 16 is the same as the polarity of the acting permanent magnet 19. Thus, the mass of magnetizable material 18 will be caused to have its induced south pole directed to the acting permanent magnet 19 and to have its induced north pole directed to first permanent magnet 17. It may be preferred that a thin coating covers one pole of the first permanent magnet 17 and/or one side of the mass of magnetizable material 18. The thin coating (not shown) may be of the plastic material of the coupling body 16 or of another material (e.g. PTFE). In consequence, the magnetic field between the north pole of the acting permanent magnet 19 and the induced south pole of the mass of magnetizable material 18 build up the magnetic working connection between the actuation unit 20 and the coupling body 16 here. The magnetic field between the north pole of the first permanent magnet 17 and the magnetizable material 13 build up the magnetic working connection between the coupling body 16 and the mixing body 12 here.

Starting from top, the fourth variant in FIG. 2 is characterized in that the coupling body 16 comprises one first permanent magnet 17 and one second permanent magnet 17′ that both only fill a part of the coupling body 16, but that both are aligned on a first essentially horizontal axis 21. This first permanent magnet 17 has one of the poles directed to the mixing body 12 and the other pole directed to the inside of the coupling body 16 and towards the second permanent magnet 17′. This second permanent magnet 17′ has one of the poles directed to first permanent magnet 17 and the other pole directed to the acting permanent magnet 19 that preferably is attached to an actuating unit 20. It is preferred that the polarity of the first and second permanent magnets 17,17′ of the coupling body 16 is the same as the polarity of the acting permanent magnet 19. It may be preferred that a thin coating covers one pole of the first permanent magnet 17 and/or one pole of the second permanent magnet 17′. The thin coating (not shown) may be of the plastic material of the coupling body 16 or of another material (e.g. PTFE). In consequence, the magnetic field between the north pole of the acting permanent magnet 19 and the south pole of the second permanent magnet 17′ build up the magnetic working connection between the actuation unit 20 and the coupling body 16 here. The magnetic field between the north pole of the first permanent magnet 17 and the magnetizable material 13 build up the magnetic working connection between the coupling body 16 and the mixing body 12 here. In the fourth variant just described, the acting material of the actuation unit 20 could be a magnetizable material 19′ instead of a permanent magnet 19.

As demonstrated with the four exemplary variants of coupling bodies 16 in FIG. 2, for each container 2, there is located on a first essentially horizontal axis 21:
one mixing body 12 in the working part 5 of the inner chamber 3 of the container 2, the mixing body 12 being spaced apart by the distance 15 from the wall 8; and
   a first permanent magnet 17 or a mass of magnetizable material 18 of the coupling body 16 in the interspace 9; and optionally
   a second permanent magnet 17′ or a mass of magnetizable material 18 of the coupling body 16 in the interspace 9; and
one acting permanent magnet 19 or one acting magnetizable material 19′ attached to an actuating unit 20 of the mixing device 1.

FIG. 3 shows three variants of angular arranging a mixing body 12 and a coupling body 16 along a first essentially horizontal axis 21 in combination with arranging the coupling body 16 and an acting permanent magnet 19 or acting magnetizable material 19′ along a second essentially horizontal axis 21′. The angle between the first and second essentially horizontal axis 21,21′ preferably is 90°. In this FIG. 3, all mixing bodies 12 comprise a magnetizable material 13 and are shown without a cover layer 42 that would coat the magnetizable material 13. All coupling bodies 16 are shown to almost fill the area of the interspace 9 between the wall 8 of the inner chamber 2 and the external encasement 6 so that the coupling body 16 is guided in its movement along the longitudinal axis 4 of the inner chamber 3 on all sides. Of course, there need to be some play on all sides of the coupling body 16 so that it may freely move in the desired direction. Preferably, the coupling body 16 comprises a combination of materials, a plastic body material and a material that is selected from a group of materials consisting of a first permanent magnet 17, a second permanent magnet 17′, and a magnetizable material 18. The plastic material preferably is polytetrafluorethylene (PTFE) that exhibits lubricant characteristics. The first and second permanent magnets 17,17′ preferably are from composites of rare earths because of their strong magnetic field. The magnetizable material 18 can be selected for example from iron, nickel, rare earths, from alloys or composite materials that comprise iron, nickel or rare earths, or from any other magnetizable material.

In general, all acting permanent magnets 19 are arranged such that one of the poles (the north pole for all examples discussed in this patent application; it could as well be the south pole however) is directed to the container 2 that the acting permanent magnet 19 is dedicated to.

Each coupling body 16 accomplishes the task of bridging the long distance between one or more mixing bodies 12 in the inner chamber 3 of a particular container 2 and the acting permanent magnet 19 that is dedicated to this particular container 2. In addition, the mixing bodies 12 are offset with respect to the second horizontal essentially axis 21′ and thus even less influenced by the magnetic field of the respective acting permanent magnet 19. This task is accomplished on the one hand by minimizing the distance between the one or more mixing bodies 12 in the inner chamber 3 of a particular container 2 and the coupling body 16 in the interspace 9 of this container 2. This task is accomplished on the other hand by minimizing the distance between the coupling body 16 in the interspace 9 of this container 2 and the acting permanent magnet 19 that is dedicated to this particular container 2.

Starting from top, the first variant in FIG. 3 is characterized in that the coupling body 16 comprises a mass of magnetizable material 18 that reaches to the surface of two adjacent angular surfaces of the coupling body 16 in the direction of a first essentially horizontal axis 21 and of a second essentially horizontal axis 21′. This mass of magnetizable material 18 has one of its sides directed to the mixing body 12 and the angled side directed to the acting permanent magnet 19 that preferably is attached to an actuating unit 20. It may be preferred that a thin coating covers one or both of these sides of the mass of magnetizable material 18. The thin coating (not shown) may be of the plastic material of the coupling body 16 or of another material (e.g. PTFE). In consequence, the magnetic field between the north pole of the acting permanent magnet 19 and the induced south pole of the mass of magnetizable material 18 build up the magnetic working connection between the actuation unit 20 and the coupling body 16 here. The magnetic field between the induced north pole of the mass of magnetizable material 18 and the magnetizable material 13 build up the magnetic working connection between the coupling body 16 and the mixing body 12 here. In the first variant just described, the mixing body 12 could comprise a permanent magnet 13′ instead of a magnetizable material 13.

Starting from top, the second variant in FIG. 3 is characterized in that the coupling body 16 comprises one first permanent magnet 17 and a mass of magnetizable material 18 that both only fill a part of the coupling body 16. The first permanent magnet 17 is aligned on the first essentially horizontal axis 21 and the magnetizable material 18 is aligned on the second essentially horizontal axis 21′. This first permanent magnet 17 has one of the poles directed to the mixing body 12 and the other pole directed to the inside of the coupling body 16. One side of the mass of magnetizable material 18 is directed to the acting permanent magnet 19 that preferably is attached to an actuating unit 20; the other side of the mass of magnetizable material 18 is directed to the inside of the coupling body 16. It is preferred that the polarity of the first permanent magnet 17 of the coupling body 16 is such that the north pole is directed against the mixing body 12 (if the north pole of the acting permanent magnet 19 is directed towards the container 2). Thus, the mass of magnetizable material 18 will be caused to have its induced south pole directed to the acting permanent magnet 19 and to have its induced north pole directed to first permanent magnet 17. It may be preferred that a thin coating covers one pole of the first permanent magnet 17 and/or one side of the mass of magnetizable material 18. The thin coating (not shown) may be of the plastic material of the coupling body 16 or of another material (e.g. PTFE). In consequence, the magnetic field between the north pole of the acting permanent magnet 19 and the induced south pole of the mass of magnetizable material 18 build up the magnetic working connection between the actuation unit 20 and the coupling body 16 here. The magnetic field between the north pole of the first permanent magnet 17 and the magnetizable material 13 build up the magnetic working connection between the coupling body 16 and the mixing body 12 here.

Starting from top, the third variant in FIG. 3 is characterized in that the coupling body 16 comprises one first permanent magnet 17 and one second permanent magnet 17′ that both only fill a part of the coupling body 16. The first permanent magnet 17 is aligned on the first essentially horizontal axis 21 and the second permanent magnet 17′ is aligned on the second essentially horizontal axis 21′. This first permanent magnet 17 has one of the poles directed to the mixing body 12 and the other pole directed to the inside of the coupling body 16. This second permanent magnet 17′ has one of the poles directed to the acting permanent magnet 19 that preferably is attached to an actuating unit 20; the other pole of the second permanent magnet 17′ is directed to the inside of the coupling body 16. It is preferred that the polarity of the first permanent magnet 17 of the coupling body 16 is such that the north pole is directed against the mixing body 12 (if the north pole of the acting permanent magnet 19 is directed towards the container 2). It is further preferred that the polarity of the second permanent magnet 17′ is the same as the polarity of the acting permanent magnet 19. It may be preferred that a thin coating covers one pole of the first and or second permanent magnet 17,17′. The thin coating (not shown) may be of the plastic material of the coupling body 16 or of another material (e.g. PTFE). In consequence, the magnetic field between the north pole of the acting permanent magnet 19 and the south pole of second permanent magnet 17′ build up the magnetic working connection between the actuation unit 20 and the coupling body 16 here. The magnetic field between the north pole of the first permanent magnet 17 and the magnetizable material 13 build up the magnetic working connection between the coupling body 16 and the mixing body 12 here. In the third variant just described, the acting material of the actuation unit 20 could be a magnetizable material 19′ instead of a permanent magnet 19.

As demonstrated with the three exemplary variants of coupling bodies 16 in FIG. 3, for each container 2, there is located on a first essentially horizontal axis 21:
one mixing body 12 in the working part 5 of the inner chamber 3 of the container 2, the mixing body 12 being spaced apart by the distance 15 from the wall 8; and
a first permanent magnet 17 or a mass of magnetizable material 18 of the coupling body 16 in the interspace 9;
   and there is located on a second essentially horizontal axis 21′:
a second permanent magnet 17′ or a mass of magnetizable material 18 of the coupling body 16 in the interspace 9; and
one acting permanent magnet 19 or one acting magnetizable material 19′ attached to an actuating unit 20 of the mixing device 1.

FIG. 4 shows additional variants of linearly arranging at least one mixing body 12, a coupling body 16, and an acting permanent magnet 19 or acting magnetizable material 19′ along a first or second horizontal axis 21,21′. The angle between the first and second essentially horizontal axes 21,21′ preferably is 90°. In this FIG. 4, all mixing bodies 12 comprise a magnetizable material 13 and are mostly shown without a cover layer 42 that would coat the magnetizable material 13. Some coupling bodies 16 are shown to almost fill the area of the interspace 9 between the wall 8 of the inner chamber 2 and the external encasement 6 so that the coupling body 16 is guided in its movement along the longitudinal axis 4 of the inner chamber 3 on all sides. Of course, there need to be some play on all sides of the coupling body 16 so that it may freely move in the desired direction. Preferably, the coupling body 16 comprises a combination of materials, a plastic body material and a material that is selected from a group of materials consisting of a first permanent magnet 17, a secand permanent magnet 17′, and a magnetizable material 18. The plastic material preferably is polytetrafluorethylene (PTFE) that exhibits lubricant characteristics. The first and second permanent magnets 17,17′ preferably are from composites of rare earths because of their strong magnetic field. The magnetizable material 18 can be selected for example from iron, nickel, rare earths, from alloys or composite materials that comprise iron, nickel or rare earths, or from any other magnetizable material.

In general, all acting permanent magnets 19 are arranged such that one of the poles (the north pole for all examples discussed in this patent application) is directed to the container 2 that the acting permanent magnet 19 is dedicated to.

Each coupling body 16 accomplishes the task of bridging the long distance between one or more mixing bodies 12 in the inner chamber 3 of a particular container 2 and the acting permanent magnet 19 that is dedicated to this particular container 2. In addition, some mixing bodies 12 may be offset with respect to the second essentially horizontal axis 21′ and thus are even less influenced by the magnetic field of the respective acting permanent magnet 19. This task is accomplished on the one hand by minimizing the distance between the one or more mixing bodies 12 in the inner chamber 3 of a particular container 2 and the coupling body 16 in the interspace 9 of this container 2. This task is accomplished on the other hand by minimizing the distance between the coupling body 16 in the interspace 9 of this container 2 and the acting permanent magnet 19 or acting magnetizable material 19′ that is dedicated to this particular container 2.

Starting from top, the first variant in FIG. 4 is characterized in that the coupling body 16 comprises two first permanent magnets 17 and one second permanent magnet 17′ that all only fill a part of the coupling body 16. The two first permanent magnets 17 are aligned on two first essentially horizontal axes 21 and the second permanent magnet 17′ is aligned on the second essentially horizontal axis 21′. All essentially horizontal axes 21,21′ preferably extend in a perpendicular direction with respect to the actuating unit 20 and the acting permanent magnet 19 or acting magnetizable material 19′ mounted thereon. Both first permanent magnets 17 have one of the poles directed to one of the two mixing bodies 12 that are present in the inner chamber 3 of the container 2. The other pole of the first permanent magnets 17 is directed to the inside of the coupling body 16. This second permanent magnet 17′ has one of the poles directed to the acting permanent magnet 19 that preferably is attached to an actuating unit 20; the other pole of the second permanent magnet 17′ is directed to the inside of the coupling body 16. It is preferred that the polarity of the first and second permanent magnets 17,17′ of the coupling body 16 is the same as the polarity of the acting permanent magnet 19 that is dedicated to the container 2. It may be preferred that a thin coating covers one pole of the first and or second permanent magnets 17,17′. The thin coating (not shown) may be of the plastic material of the coupling body 16 or of another material (e.g. PTFE). In consequence, the magnetic field between the north pole of the acting permanent magnet 19 and the south pole of the second permanent magnet 17′ build up the magnetic working connection between the actuation unit 20 and the coupling body 16 here. The magnetic field between the north poles of the two first permanent magnets 17 and the magnetizable materials 13 build up the magnetic working connection between the coupling body 16 and the two mixing bodies 12 here. In the first variant just described, the acting material of the actuation unit 20 could be a magnetizable material 19′ instead of a permanent magnet 19.

Starting from top, the second variant in FIG. 4 is characterized in that the coupling body 16 comprises one first permanent magnet 17 that reaches through the entire coupling body 16 in the direction of a first essentially horizontal axis 21. This first permanent magnet 17 has one of the poles directed to the three mixing bodies 12 inside the inner chamber 3 of the container 2 and the other pole directed to the acting permanent magnet 19 that preferably is attached to an actuating unit 20. It may be preferred that a thin coating covers one or both poles of the first permanent magnet 17. The thin coating (not shown) may be of the plastic material of the coupling body 16 or of another material (e.g. PTFE). It is preferred that the polarity of the first permanent magnet 17 of the coupling body 16 is the same as the polarity of the acting permanent magnet 19. In consequence, the magnetic field between the north pole of the acting permanent magnet 19 and the south pole of the first permanent magnet 17 build up the magnetic working connection between the actuation unit 20 and the coupling body 16 here. The magnetic field between the north pole of the first permanent magnet 17 and the magnetizable materials 13 build up the magnetic working connection between the coupling body 16 and the three mixing bodies 12 here. In the second variant just described, the acting material of the actuation unit 20 could be a magnetizable material 19′ instead of a permanent magnet 19.

Starting from top, the third variant in FIG. 4, if referring to magnetic coupling, is very similar to the first variant in FIG. 2; thus, everything said there also applies here. However and if compared with the FIGS. 2 to 3, all variants of FIG. 4 show different arrangements of the wall 8 and inner chamber 3 of the container 2 (see below). In addition, the third variant in FIG. 4 shows a different arrangement of the coupling body 16 (see below).

It is preferred that the mixing device 1 comprises at least one container 2 and that the chamber cross-section area 3′ of the working part 5 of the inner chamber 3 is selected from a group of cross-section areas that consists of circles, ellipses, ovals, polygons, and combinations of circles, ellipses, ovals, and polygons.

An example of an inner chamber 3 that comprises two volumes with circular cross section in each case is presented in the first variant of FIG. 4. The inner chamber 3 has a shape that is similar to the FIG. 8 with two volumes extending parallel to each other. Preferably in this case, the chamber cross-section area 3′ of the working part 5 of the inner chamber 3 is a combination of two equal circles that are connected by a longitudinal duct 22. The longitudinal duct 22 may be a single slit that extends over the entire working part 5 of the inner chamber 3; alternatively, two or more shorter longitudinal ducts 22 may fluidly connect the two volumes of the inner chamber 2. This inner chamber 3 provides about double the volume of a circular inner chamber 3.

An example of an inner chamber 3 with a cross-section that is different from circular is presented in the second variant of FIG. 4. The inner chamber 3 has a triangular shape with rounded corners. This inner chamber 3 provides about threefold the volume of a circular inner chamber 3.

It is however preferred that the chamber cross-section area 3′ of the working part 5 of the inner chamber 3 is a single circle as shown in the third variant of FIG. 4 (see also FIGS. 1-3 and 5). It is also preferred that the working part 5 of the inner chamber 3 extends from the upper part to the bottom 10 of the inner chamber 3 of the container 2, because on the one hand, a maximal volume is dedicated for carrying our mixing therein. On the other hand, de-molding of a container 2 that is produced by injection molding is much easier, if there are no bottle necks in the inner chamber 3. Except in this third variant of FIG. 4, all walls 8 of the inner chamber 3 are not shown to have contact sites with the external encasement 6 along the wall 8. In contrast, in this third variant of FIG. 4, there are three stabilization bars 41 indicated that connect the wall 8 along a part or along the entire wall 8 with the external encasement 6. Deviating from this third variant in FIG. 4, only one or two stabilization bars 41 can be applied. Such stabilization bars 41 hinder horizontal movements of the inner chamber 3 during mixing of liquids.

In this third variant of FIG. 4, the coupling body 16 is attached to a linear guide 43 that provides exact movement of the coupling body 16 parallel to the longitudinal axis 4 of the inner chamber 3. Provided there is enough room in the interspace 9 of the containers 2, such linear guides 43 for the coupling body 16 could also be chosen in combination with all other variants of the coupling body 16 as exemplarily presented in the FIGS. 2 to 4.

FIG. 5 shows a particularly preferred variant of arranging one mixing body 12 (preferably of magnetizable material 13 with gold coating 42), a coupling body 16, and an acting permanent magnet 19 along a first, second, and third essentially horizontal axis 21,21′,21″ in a mixing device 1. The first at least approximately or essentially horizontal axis 21 preferably runs parallel to the external encasement 6 of the container 2 and parallel to the actuation unit 20. The second at least approximately horizontal axis 21′ preferably runs at a positive oblique angle α (alpha) with respect to the first axis 21. The third at least approximately horizontal axis 21″ preferably runs at a negative oblique angle β (beta) with respect to the first axis 21. Preferably, the angles α and β are of the same or similar or equal size and have a value between 15° and 45°, preferably of 30°.

Parallel to the second axis 21′, the first permanent magnet 17 of the coupling body 16 is arranged, preferably having the north pole orientated against the mixing body 12 and the south pole pointing away from the mixing body 12. Parallel to the third essentially horizontal axis 21″, the acting permanent magnet 19 of the actuation unit 20 is arranged, preferably having the north pole orientated against an intersection 46 between the second and third axis 21′,21″ and the south pole pointing away from the intersection 46. As in all other variants already described, the acting permanent magnet 19 is immovably fixed to the actuation unit 20 and has at least a main part of the north pole exposed.

Departing from the geometrical arrangement and orientation of the coupling body and first permanent magnet 16,17 as well as of the acting permanent magnet 19 as depicted in FIG. 5 (but still within the gist of the present invention), the second at least approximately horizontal axis 21′ may run at a positive oblique angle α (alpha) with respect to the first axis 21 in a range of 15° to 165°, preferably in a range of 30° to 150°. In addition, the third at least approximately horizontal axis 21″ preferably runs at a negative oblique angle β (beta) with respect to the first axis 21 in a range of −15° to −165°, preferably in a range of −30° to −150°. Thus, among others, the following alternative arrangements can be chosen, even if they may be less preferred than the arrangement in FIG. 5:
a) The coupling body and first permanent magnet 16,17 is arranged and orientated in its polarity as shown in FIG. 5. However, the acting permanent magnet 19 is arranged such that the third essentially horizontal axis 21″ runs at least approximately parallel to the second essentially horizontal axis 21′ and that the acting permanent magnet 19 has the same orientation of the poles as the first permanent magnet 17. With respect to the position in FIG. 5, the acting permanent magnet 19 is placed offset (downwards in the FIG. 5) such that the most exposed corner of the acting permanent magnet 19 is in close vicinity with the corner of the coupling body and first permanent magnet 16,17 that is next to the actuating unit 20.
b) The coupling body and first permanent magnet 16,17 is arranged and orientated in its polarity as shown in FIG. 5. However, the acting permanent magnet 19 is arranged such that the third essentially horizontal axis 21″ runs at least approximately perpendicular to the actuating unit 20, opposed poles of the two magnets 17,19 pointing against each other. With respect to the position in FIG. 5, the acting permanent magnet 19 is placed offset (downwards in the FIG. 5) such that the intersection 46 between the second and third essentially horizontal axes 21′,21″ is located in-between these opposed poles of the two magnets 17,19 and that the corner of the coupling body and first permanent magnet 16,17 that is next to the actuating unit 20 is in close vicinity with one corner of the acting permanent magnet 19.

Deviating form all variants described above (see FIGS. 2 to 4), the first permanent magnet 17 of all arrangements described with respect to FIG. 5 is identical with the movable coupling body 16.

In FIG. 5, a guide 51 for the coupling body 16 almost completely fills the interspace 9 of the container 2 and has a guiding bore 47 that is adapted to the shape and size of the first permanent magnet 17 (i.e. the coupling body). The guiding bore 47 may be considerably larger than the first permanent magnet 17 (see FIG. 5) or it can be only marginally larger to just allow easy reciprocal movement of the permanent magnet 17. The guiding bore 47 preferably extends in proximity to a container bore 48 that takes up the wall 8 of the container 2. The guiding bore 47 and the container bore 48 preferably extend parallel to the longitudinal axis 4 of the inner chamber 3 of the container 2. The guiding bore 47 thus provides the movable coupling body 16,17 with an equivalent of a linear guide along the longitudinal axis 4 of the inner chamber 3 of the container 2.

The guide 51 for the coupling body 16 has an external shape and size that fits to be inserted through the bottom opening 7 (see FIG. 1 or 6) and into the interspace 9 of the container 2. The guide 51 preferably is produced by injection molding of polymer material (e.g. from polypropylene) and may comprise one or more longitudinal ducts or slits 22 (two being shown) that penetrate the guide 51 in the region of the container bore 48. The guide 51 for the coupling body 16 (i.e. the first permanent magnet 17 here) preferably is configured as a seat for taking up one container 2. The guide 51 for the coupling body 16 is configured to be immovable during mixing of liquids in the respective container 2.

Also shown in FIG. 5 is a light metal wall 44 that preferably is placed in-between the external encasement 6 of the container 2 and the acting permanent magnet 19. As the light metal wall 44 is transparent to a magnetic field, magnetic coupling through this light metal wall 44 is not affected or disturbed. Preferably, the light metal wall 44 is a part of a thermal insulation box 49 (see FIG. 6) which comprises an insulated wall 45 (preferably of a plastics material) and a light metal wall 44 (preferably of aluminum, magnesium, or a light metal alloy).

FIG. 6 shows a vertical section through a mixing device 1 according to a second embodiment that is configured as a liquid handling workstation. This device 1 is suited for mixing liquids of different viscosity or composition within at least one container 2 as already has been described in connection with FIG. 1. Here, the mixing device 1 preferably is configured for working with a series of containers 2 (only one being cut by the section). A decapper 27 has taken the screw cap 24 from the neck portion 11′ of the transfer opening 11 of the inner chamber 3 of the container 2. This decapper 27 can be robotized and part of the workstation, or this decapper 27 can be an operator that manually takes away the screw cap 24 from the container 2. A pipette 28 of the liquid handling workstation is piercing the lid 25 of the transfer opening 11 and is currently used for aspirating mixed buffers or reagents for staining biological specimens on light microscopy slides.

In all containers 2 preferred, the chamber cross-section area 3′ of the working part 5 of the inner chamber 3 is a single circle and the working part 5 of the inner chamber 3 extends from the upper part to the bottom 10 of the inner chamber 3 of the container 2. For each container 2, there is located on a first essentially horizontal axis 21 at least one mixing body 12 in the working part 5 of the inner chamber 3 of the container 2. The mixing body 12 is spaced apart by the distance 15 from the wall 8. In the variant just described, the mixing body 12 could comprise a permanent magnet 13′ or a magnetizable material 13.

As also shown in FIG. 1, the mixing device 1 according to the second embodiment that is configured as a liquid handling workstation further comprises an actuating unit 20 to which in this case a series of acting permanent magnets 19 or acting magnetizable material 19′ is attached. The actuating unit 20 is configured to reciprocally move the series of acting permanent magnets 19 or acting magnetizable materials 19′ linearly and substantially parallel to the longitudinal axes 4 of the inner chambers 3 of the series of containers 2 that are placed at the mixing device 1.

In FIG. 6, the base 30 is configured as a drawer that is guided by guiding means 29 for moving horizontally in a drawer-like fashion. Such drawers can be utilized to feed a number of containers 2 to the mixing device 1 configured as a liquid handling workstation. Also here, the containers are prevented from vertical movements during mixing of viscose liquids by e.g. one or two blocking elements 26 and/or a number of holding members 40 that in each case preferably are connected to the support 30.

In the second embodiment of the mixing device 1, a thermal insulation box 49 is preferred for taking up the containers 2 for mixing the liquids in these containers 2. An insulated wall 45 from plastic material with a preferred thickness of 13 mm preferably surrounds the thermal insulation box 49. However and as shown, the drive axle 32 of the drive 31 for moving up and down the actuating unit 20 penetrates the insulated wall 45, so that the drive motor 31 is located outside the thermal insulation box 49. With this arrangement movement of the mixing bodies 12 can be induced without power lines leading into the thermal insulation box 49. Different to the FIG. 1, the linear guide 37 is attached to a support 39 that runs approximately horizontal and that is located outside the thermal insulation box 49.

Preferably, a light metal wall 44 is attached to the inner surface of the insulation wall 45 as an inner lining. The light metal wall 44 preferably has a thickness of 3 mm and can be of any light metal that is transparent to magnetic fields; however aluminum is the preferred material for building this light metal wall 44. In a space 50 between the insulated wall 45 and the light metal wall 44, moving parts for inducing movement of the coupling body 16 are located. In this space 50, are arranged the actuation unit 20 and the acting permanent magnet 19 or acting magnetizable material 19′, the cart 38 and the linear guide 37 as well as the drive lever 36, the drive wheel axle 34, and the drive wheel 33. In consequence, the inside of the thermal insulation box 49 (the inner surface of the light metal wall 44) can be easily cleaned as soon as all bases 30 with the containers 2 sitting thereon are withdrawn from the thermal insulation box 49.

Preferably, for properly carrying out the mixing method of the current invention, the chamber cross-section area 3′ of the working part 5 of the inner chamber 3 is selected from a group of cross-section areas that consists of circles, ellipses, ovals, polygons, and combinations of circles, ellipses, ovals, and polygons. Most preferred is a circular cross-section area 3′ of the working part 5 of the inner chamber 3.

For inducing mixing of liquids inside the inner chamber 3 of the containers 2 and thus for moving the at least one acting permanent magnet 19 or acting magnetizable material 19′, the mixing device 1 further comprises an actuating unit 20 to which the at least one acting permanent magnet 19 or acting magnetizable material 19′ is attached. This actuating unit 20 reciprocally moves the at least one acting permanent magnet 19 or acting magnetizable material 19′ linearly and substantially parallel to the longitudinal axis 4 of the inner chamber 3 of a container 2 that is placed at the mixing device 1.

Further for carrying out the mixing method, for each container 2, there is utilized one mixing body 12 in the working part 5 of the inner chamber 3 of the container 2. This mixing body 12 is spaced apart by the distance 15 from the wall 8. In addition, there is utilized a coupling body 16 in the interspace 9 of the container 2, the coupling body 16 comprising on a first essentially horizontal axis 21 a first permanent magnet 17 (shown in FIG. 6) or a mass of magnetizable material 18 (not shown in FIG. 6). A particularly preferred use of a device 1 for mixing liquids of different viscosity or composition within at least one container 2 is characterized in that the device 1 for mixing liquids of different viscosity or composition within at least one container 2 is utilized for mixing reagents or buffers used for staining cells and tissues on microscope slides.

The same reference numbers point to the same features of the inventive device 1 for mixing liquids of different viscosity or composition within at least one container 2, even if not in all instances an explanation is given for some of the numbers. Throughout the specification, there are described axes 21, 21′, and 21″ as extending essentially or approximately in a horizontal direction. These axes 21, 21′, and/or 21″ may therefore extend exactly horizontal or their direction may include an angle with respect to the horizontal direction of up to 30°.

The technical principle of reciprocal driving the actuation unit in an essentially vertical direction is shown in an exemplary embodiment in the FIGS. 1 and 6, where rotation is converted into reciprocal linear movement. However, other driving principles for linearly moving the actuation unit 20 that a skilled person would chose when knowing the present invention are comprised in the gist of the present invention. Combinations of the variants and embodiments herein described, which appear reasonable to a skilled person are comprised by the gist of the present invention.

Reference numbers

| | |
|---|---|
| 1 | Device |
| 2 | Container |
| 3 | Inner chamber of 2 |
| 3′ | Chamber cross-section area of 3 |
| 4 | Longitudinal axis of 3 |
| 5 | Working part of 3 |
| 6 | External encasement |
| 7 | Bottom opening of 6 |
| 8 | Wall of 2 |
| 9 | Interspace |
| 10 | Bottom of 2 |
| 11 | Transfer opening |
| 11′ | Neck portion of 11 |
| 12 | Mixing body |
| 13 | Magnetizable material of 12 |
| 13′ | Permanent magnet of 12 |
| 14 | Body cross-section area of 12 |
| 14′ | Sum of body cross-section areas |
| 15 | Distance |
| 16 | Coupling body |
| 17 | First permanent magnet of 16 |
| 17′ | Second permanent magnet of 16 |
| 18 | Mass of magnetizable material of |
| | 16 |
| 19 | Acting permanent magnet |
| 19′ | Acting magnetizable material |
| 20 | Actuating, actuation unit |
| 21 | 1^{st} essentially horizontal axis |
| 21′ | 2^{nd} essentially horizontal axis |
| 21″ | 3^{rd} essentially horizontal axis |
| 22 | Longitudinal duct |
| 23 | External thread of 11′ |
| 24 | Screw cap |
| 25 | Lid of 11 |
| 26 | Blocking element(s) |
| 27 | Decapper |
| 28 | Pipette |
| 29 | Guiding means |
| 30 | Base |
| 31 | Drive, drive motor |
| 32 | Drive axle |
| 33 | Drive wheel |
| 34 | Drive wheel axle |
| 35 | Long slot of 20 |
| 36 | Drive Lever |
| 37 | Linear guide |
| 38 | Cart |
| 39 | Wall or support |
| 40 | Holding member |
| 41 | Stabilization bar |
| 42 | Coating or cover layer of 12 |
| 43 | Linear guide of 16 |
| 44 | Light metal wall |
| 45 | Insulated wall |
| 46 | Intersection between 21′ & 21″ |
| 47 | Guiding bore |
| 48 | Container bore |
| 49 | Thermal insulation box |
| 50 | Space |
| 51 | Guide of 16, 17 |

1. A device (1) for mixing liquids of different viscosity or composition within at least one container (2), each container (2) comprising:
(i) an inner chamber (3) with a longitudinal axis (4) and a chamber cross-section area (3′) that extends perpendicular to the longitudinal axis (4), the chamber cross-section area (3′) being substantially constant over at least a working part (5) of the inner chamber (3);
(ii) an external encasement (6) with a bottom opening (7), the external encasement (6) being attached to the container (2) at an upper part of the latter;
(iii) a wall (8) that encloses the inner chamber (3) and that is spaced apart from the external encasement (6) by an interspace (9), the wall (8) and the external encasement (6) being configured to be transparent to magnetic fields;
(iv) a bottom (10) that is attached to the wall (8) and that closes the inner chamber (3) at a bottom side; and
(v) a transfer opening (11) that is located at a top side of the inner chamber (3);
wherein there is located within the working part (5) of the inner chamber (3) at least one mixing body (12), each mixing body (12) comprising magnetizable material (13) or a permanent magnet (13′) and defining a body cross-section area (14) that adds up to a sum of body cross-section areas (14′), the sum of body cross-section areas (14′) being less than the chamber cross-section area (3′) and the at least one mixing body (12) being spaced apart by a distance (15) from the wall (8);
wherein the mixing device (1) further comprises:
(vi) a coupling body (16) that is configured to be introducible into the interspace (9) via the bottom opening (7) of the external encasement (6) and that is movable in the interspace (9) substantially in direction of the longitudinal axis (4) and alongside the wall (8), the coupling body (16) comprising a first permanent magnet (17) and/or a mass of magnetizable material (18) that in each case through the wall (8) is in magnetic working connection with the at least one mixing body (12) such that moving the coupling body (16) alongside the wall (8) simultaneously induces moving the at least one mixing body (12) in the working part (5) of the inner chamber (3); and
wherein the mixing device (1) further comprises:
(vii) at least one acting permanent magnet (19) or acting magnetizable material (19′) that is located outside the external encasement (6) and that through the external encasement (6) is in magnetic working connection with the first permanent magnet (17), a second permanent magnet (17′), or the mass of magnetizable material (18) of the coupling body (16) such that moving the at least one acting permanent magnet (19) or acting magnetizable material (19′) at least substantially parallel to the longitudinal axis (4) of the inner chamber (3) simultaneously induces movement of the coupling body (16) inside the interspace (9), thereby moving the at least one mixing body (12) in the inner chamber (3), and thus mixing of liquids that are present in the working part (5) of the inner chamber (3) of the container (2).

2. The mixing device (1) of claim 1,
wherein the mixing device (1) comprises at least one container (2), the chamber cross-section area (3′) of the working part (5) of the inner chamber (3) being selected from a group of cross-section areas that consists of circles, ellipses, ovals, polygons, and combinations of circles, ellipses, ovals, and polygons.

3. The mixing device (1) of claim 2,
wherein the chamber cross-section area (3′) of the working part (5) of the inner chamber (3) of the container (2) is a single circle or a combination of two equal circles that are connected by a longitudinal duct (22).

4. The mixing device (1) of claim 1,
wherein the working part (5) of the inner chamber (3) of the container (2) extends from the upper part to the bottom (10) of the inner chamber (3) of the container (2).

5. The mixing device (1) of claim 1,
wherein the mixing device (1) further comprises:
(viii) an actuating unit (20) to which the at least one acting permanent magnet (19) or acting magnetizable material (19′) is attached, the actuating unit (20) being configured to move the at least one acting permanent magnet (19) or acting magnetizable material (19′) linearly and substantially parallel to the longitudinal axis (4) of the inner chamber (3) of a container (2) that is placed at the mixing device (1).

6. The mixing device (1) of claim 1,
wherein for each container (2), there is located on a first essentially horizontal axis (21):
one mixing body (12) in the working part (5) of the inner chamber (3) of the container (2), the mixing body (12) being spaced apart by the distance (15) from the wall (8); and
a first permanent magnet (17) or a mass of magnetizable material (18) of the coupling body (16) in the interspace (9); and optionally
a second permanent magnet (17′) or a mass of magnetizable material (18) of the coupling body (16) in the interspace (9); and
one acting permanent magnet (19) or acting magnetizable material (19′) attached to an actuating unit (20) of the mixing device (1).

7. The mixing device (1) of claim 1,
wherein for each container (2), there is located on a first essentially horizontal axis (21):
one mixing body (12) in the working part (5) of the inner chamber (3) of the container (2), the mixing body (12) being spaced apart by the distance (15) from the wall (8); and
a first permanent magnet (17) or a mass of magnetizable material (18) of the coupling body (16) in the interspace (9); and
wherein for each container (2), there is located on a second essentially horizontal axis (21′):
a second permanent magnet (17′) or a mass of magnetizable material (18) of the coupling body (16) in the interspace (9); and
one acting permanent magnet (19) or acting magnetizable material (19′) attached to an actuating unit (20) of the mixing device (1).

8. The mixing device (1) of claim 1,
wherein for each container (2), there is located on a first essentially horizontal axis (21) a mixing body (12), on a second essentially horizontal axis (21′) a coupling body (16), and on a third essentially horizontal axis 21″ an acting permanent magnet (19); the coupling body (16) being a first permanent magnet (17) and movably located inside a guiding bore (47) of a guide (51) that is inserted into the interspace (9) of the container (2).

9. The mixing device (1) of claim 8,
wherein the second at least approximately horizontal axis (21′) runs at a positive oblique angle (α) with respect to the first axis (21) and the third at least approximately horizontal axis (21″) runs at a negative oblique angle (β) with respect to the first axis (21).

10. The mixing device (1) of claim 1,
wherein each container (2) comprises a coupling body (16) that is introduced into and that is movable within the interspace (9) of the container (2).

11. The mixing device (1) of claim 1,
wherein the mixing device (1) is configured to take up at least one container (2), each container (2) comprising at least one mixing body (12) that is located in the inner chamber (3), and each container (2) having a gold coating (42) on its surface.

12. The mixing device (1) of claim 1,
wherein the transfer opening (11) of the container (2) comprises an external thread (23) for sealingly attaching a screw cap (24) that closes the inner chamber (3) of the container (2), the external thread (23) protruding beyond the external encasement (6) of the container (2).

13. The mixing device (1) of claim 1,
wherein the transfer opening (11) of the container (2) comprises a lid (25)
that is sealingly attached and that closes the inner chamber (3) of the container (2), the transfer opening (11) being protruding over or flush with the external encasement (6) of the container (2).

14. The mixing device (1) of claim 1,
wherein the mixing device (1) is configured as a stand-alone device or is integrated into a liquid handling workstation.

15. Method of mixing liquids of different viscosity or composition within at least one container (2), using a mixing device (1) according to claim 1, the method comprising:
a) introducing of liquids to be mixed into an inner chamber (3) of a container (2) of the mixing device (1), each container (2) comprising:
(i) an inner chamber (3) with a longitudinal axis (4) and a chamber cross-section area (3′) that extends perpendicular to the longitudinal axis (4), the chamber cross-section area (3′) being substantially constant over at least a working part (5) of the inner chamber (3);
(ii) an external encasement (6) with a bottom opening (7), the external encasement (6) being attached to the container (2) at an upper part of the latter;
(iii) a wall (8) that encloses the inner chamber (3) and that is spaced apart from the external encasement (6) by an interspace (9), the wall (8) and the external encasement (6) being configured to be transparent to magnetic fields;
(iv) a bottom (10) that is attached to the wall (8) and that closes the inner chamber (3) at a bottom side; and
(v) a transfer opening (11) that is located at a top side of the inner chamber (3);
b) placing within the working part (5) of the inner chamber (3) at least one mixing body (12), each mixing body (12) comprising magnetizable material (13) or a permanent magnet (13′) and defining a body cross-section area (14) that adds up to a sum of body cross-section areas (14′), the sum of body cross-section areas (14′) being less than the chamber cross-section area (3′) and the at least one mixing body (12) being spaced apart by a distance (15) from the wall (8);
c) introducing a coupling body (16) into the interspace (9) via the bottom opening (7) of the external encasement (6), the coupling body (16) being movable in the interspace (9) substantially in direction of the longitudinal axis (4) and alongside the wall (8), the coupling body (16) comprising a first permanent magnet (17) and/or a mass of magnetizable material (18) that in each case through the wall (8) is in magnetic working connection with the at least one mixing body (12) such that moving the coupling body (16) alongside the wall (8) simultaneously induces moving the at least one mixing body (12) in the working part (5) of the inner chamber (3); and
d) moving at least one acting permanent magnet (19) or acting magnetizable material (19′), which is located outside the external encasement (6), and which through the external encasement (6) is in magnetic working connection with the first permanent magnet (17), a second permanent magnet (17′), or the mass of magnetizable material (18) of the coupling body (16), at least substantially parallel to the longitudinal axis (4) of the inner chamber (3), simultaneously inducing movement of the coupling body (16) inside the interspace (9), thereby moving the at least one mixing body (12) in the inner chamber (3), and thus mixing of liquids that are present in the working part (5) of the inner chamber (3) of the container (2).

16. The mixing method of claim 15,
wherein for moving the at least one acting permanent magnet (19) or acting magnetizable material (19′), the mixing device (1) further comprises an actuating unit (20) to which the at least one acting permanent magnet (19) or acting magnetizable material (19′) is attached, and
wherein the actuating unit (20) moves the at least one acting permanent magnet (19) or acting magnetizable material (19′) linearly and substantially parallel to the longitudinal axis (4) of the inner chamber (3) of a container (2) that is placed at the mixing device (1).

17. The mixing method of claim 15,
wherein for each container (2), there is utilized one mixing body (12) in the working part (5) of the inner chamber (3) of the container (2), the mixing body (12) being spaced apart by the distance (15) from the wall (8); and there is utilized a coupling body (16) in the interspace (9) of the container (2), the coupling body (16) comprising on a first essentially horizontal axis (21) a first permanent magnet (17) or a mass of magnetizable material (18).

18. The mixing method of claim 17,
wherein the coupling body (16) further comprises on a second essentially horizontal axis (21′) a second permanent magnet (17′) or a mass of magnetizable material (18)

19. A method of using a device (1) for mixing liquids of different viscosity or composition within at least one container (2), each container (2) comprising:
(i) an inner chamber (3) with a longitudinal axis (4) and a chamber cross-section area (3′) that extends perpendicular to the longitudinal axis (4), the chamber cross-section area (3′) being substantially constant over at least a working part (5) of the inner chamber (3);
(ii) an external encasement (6) with a bottom opening (7), the external encasement (6) being attached to the container (2) at an upper part of the latter;
(iii) a wall (8) that encloses the inner chamber (3) and that is spaced apart from the external encasement (6) by an interspace (9), the wall (8) and the external encasement (6) being configured to be transparent to magnetic fields;
(iv) a bottom (10) that is attached to the wall (8) and that closes the inner chamber (3) at a bottom side; and
(v) a transfer opening (11) that is located at a top side of the inner chamber (3);
wherein there is located within the working part (5) of the inner chamber (3) at least one mixing body (12), each mixing body (12) comprising magnetizable material (13) or a permanent magnet (13′) and defining a body cross-section area (14) that adds up to a sum of body cross-section areas (14′), the sum of body cross-section areas (14′) being less than the chamber cross-section area (3′) and the at least one mixing body (12) being spaced apart by a distance (15) from the wall (8);
wherein the mixing device (1) further comprises:
(vi) a coupling body (16) that is configured to be introducible into the interspace (9) via the bottom opening (7) of the external encasement (6) and that is movable in the interspace (9) substantially in direction of the longitudinal axis (4) and alongside the wall (8), the coupling body (16) comprising a first permanent magnet (17) and/or a mass of magnetizable material (18) that in each case through the wall (8) is in magnetic working connection with the at least one mixing body (12) such that moving the coupling body (16) alongside the wall (8) simultaneously induces moving the at least one mixing body (12) in the working part (5) of the inner chamber (3); and
wherein the mixing device (1) further comprises:
(vii) at least one acting permanent magnet (19) or acting magnetizable material (19′) that is located outside the external encasement (6) and that through the external encasement (6) is in magnetic working connection with the first permanent magnet (17), a second permanent magnet (17′), or the mass of magnetizable material (18) of the coupling body (16) such that moving the at least one acting permanent magnet (19) or acting magnetizable material (19′) at least substantially parallel to the longitudinal axis (4) of the inner chamber (3) simultaneously induces movement of the coupling body (16) inside the interspace (9), thereby moving the at least one mixing body (12) in the inner chamber (3), and thus mixing of liquids that are present in the working part (5) of the inner chamber (3) of the container (2); and
(viii) at least one container (2).

20. The method of claim 19,
wherein the device (1) for mixing liquids of different viscosity or composition within at least one container (2) is utilized for mixing reagents or buffers used for staining cells and tissues on microscope slides.
